(19) United States
(12) Patent Application Publication
(10) Pub. No.: US 2007/0041584 A1
(43) Pub. Date: Feb. 22, 2007

(54) Method for providing activation key protection

(76) Inventors: Clint H. O'Connor, Austin, TX (US); Douglas M. Anson, Dripping Springs, TX (US)

Correspondence Address: HAMILTON & TERRILE, LLP, P.O. BOX 203518, AUSTIN, TX, 78720, US

(21) Appl. No.: 11/204,984

(22) Filed: Aug. 16, 2005

(51) Int. Cl. H04L 9/00

(52) U.S. Cl. 380/45

(57) ABSTRACT

A software activation method is disclosed which uses a two-key paradigm. The method provides increased piracy protection while providing a relatively straight forward process for a user to satisfy a license claim.

### BACKGROUND OF THE INVENTION

1. Field of the Invention

The present invention relates in general to the field of information handling systems and, more particularly, to providing activation key protection for software loaded onto an information handling system.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use, such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In recent years, there has been an increase in the number of information handling systems that are manufactured based on a “build to order” process that allows a customer to specify hardware and software options. Currently, a “build to order” manufacturer often ships information handling systems from the factory to the customer. In the case of smaller customers, the customer may receive the system directly. With build to order systems, one or more software applications, such as operating system and application programs, may be installed during the build process.

It is known to enable activation of software applications via an activation key. Known activation systems are activated via a single key paradigm. The activation key is a value basis representing a valid license claim to use the corresponding program. One issue relating to activation keys is that because the license is based on a single key and the key is readily visible and readable, theft of the software is relatively easy.

Accordingly, it would be desirable to provide an activation method which is easy for a user to activate while discouraging theft of the software.

### SUMMARY OF THE INVENTION

In accordance with the present invention, a software activation method is disclosed which uses a two-key paradigm. The method provides increased piracy protection while providing a relatively straight forward process for a user to satisfy a license claim.

More specifically, the method uses two keys that are paired together to provide a super key during a manufacturing stage of installation of the application (e.g., during the operating system build). The super key is then used to represent and provide proof of a valid license. After the license has been validated, one of the two keys is disposed of. The remaining key is affixed to the target system and is used for any subsequent verification requests. While the remaining key can be used to claim a valid license proof, the remaining key cannot be used to reactivate the license. (Both of the original keys are required for activation.)

In practice, the activation key is injected into the system during manufacture onto a non-volatile storage device (or a hardened key store such as a trusted platform module (TPM)) and is not visible or extractable prior to the customer initializing the system. When the customer starts up the system, the software is activated via the super key.

In one embodiment, the invention relates to a method for providing activation key protection. The method includes installing a software application onto an information handling system; providing a manufacturing key and a verification key for the software application; combining the manufacturing key and the verification key to provide an activation key; activating the software application using the activation key; and, associating the verification key with the software application to enable a user to verify proper activation and license of the software application.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of an automated build-to-order system for installing software on an information handling system.

FIG. 2 shows a system block diagram of an information handling system.

FIG. 3 shows a block diagram of components of a system for implementing a protected activation key.

FIG. 4 is a flowchart of the operation of providing a protected activation key.

FIG. 5 shows a perspective view of an example of a protected activation key.

### DETAILED DESCRIPTION

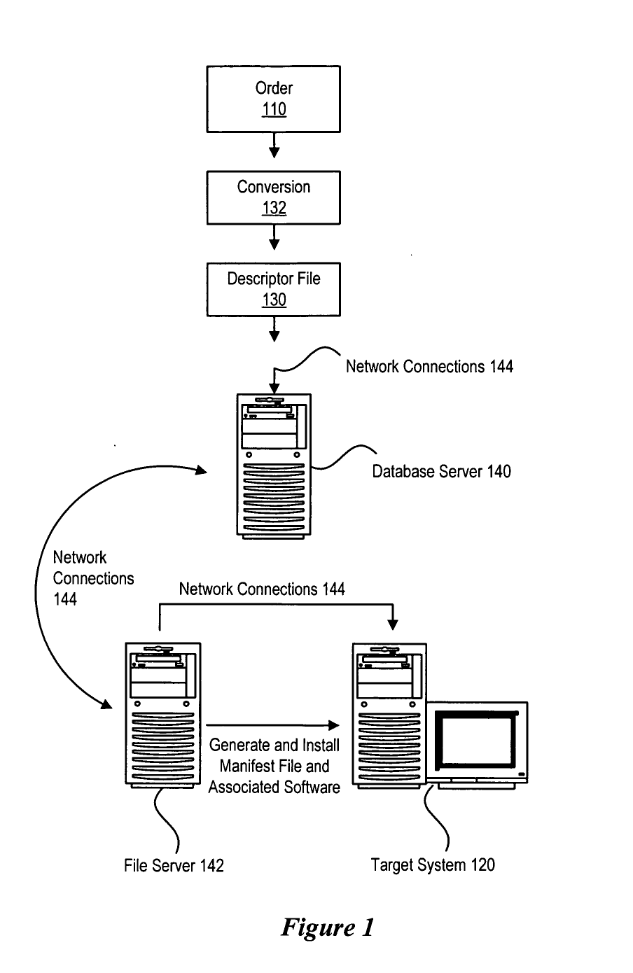

Referring to FIG. 1, a block diagram of an automated build-to-order system for installing software on an information handling system is shown. In operation, an order 110 is placed to purchase a target information handling system 120. The target information handling system 120 to be manufactured contains a plurality of hardware and software components. For instance, target information handling system 120 might include a certain brand of hard drive, a particular type of monitor, a certain brand of processor and software. The software may include a particular version of an operating system along with all appropriate driver software and other application software along with appropriate software bug fixes. Before target information handling system 120 is shipped to the customer, the plurality of components are installed and tested. Such software installation and testing advantageously ensures a reliable, working information handling system which is ready to operate when received by a customer.

Because different families of information handling systems and different individual computer components require different software installation, it is necessary to determine which software to install on a target information handling system 120. A descriptor file 130 is provided by converting an order 110, which corresponds to a desired information handling system having desired components, into a computer readable format via conversion module 132.

Component descriptors are computer readable descriptions of the components of target information handling system 120 which components are defined by the order 110. In an embodiment of the present invention, the component descriptors are included in a descriptor file called a system descriptor record, which is a computer readable file containing a listing of the components, both hardware and software, to be installed onto target information handling system 120. Having read the plurality of component descriptors, database server 140 provides a plurality of software components corresponding to the component descriptors to file server 142 over network connection 144. Network connections 144 may be any network connection well-known in the art, such as a local area network, an intranet, or the internet. The information contained in database server 140 is often updated such that the database contains a new factory build environment. The software is then installed on the target information handling system 120. The software installation is controlled by a software installation management server that is operable to control the installation of the operating system and other software packages specified by a customer.

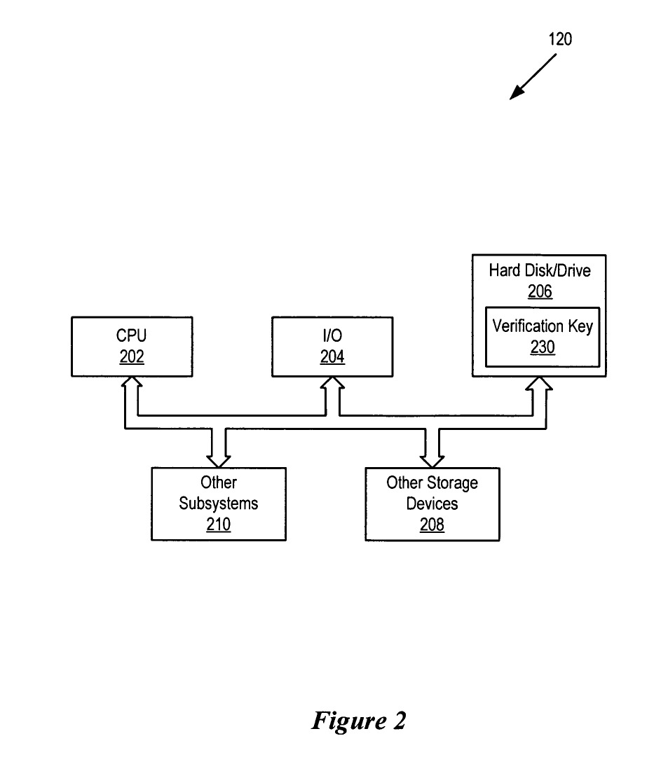

Referring to FIG. 2, a system block diagram of a generalized illustration of an information handling system, such as the target information handling system 120 is shown. The information handling system includes a processor 202, input/output (I/O) devices 204, such as a display, a keyboard, a mouse, and associated controllers, a hard disk drive 206, and other storage devices 208, such as a floppy disk and drive and other memory devices, and various other subsystems 210, all interconnected via one or more buses 212. The software that is installed according to the versioning methodology is installed onto hard disk drive 206. Alternately, the software may be installed onto any appropriate non-volatile memory. The non-volatile memory may also store information relating to a verification key 230. Accessing this verification key information enables a user to obtain information relating to activated software on the information handling system 120.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices, as well as various input and output (I/O) devices, such as a keyboard, a mouse, and a video display. The information handling system may also include one or more buses operable to transmit communications between the various hardware components.

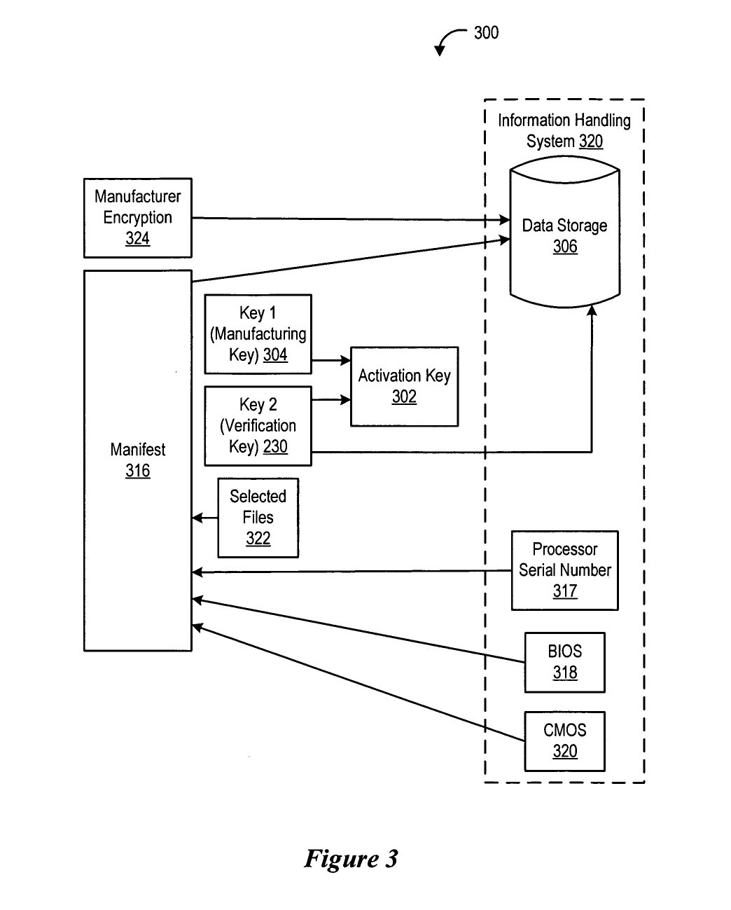

Referring to FIG. 3, a block diagram of components of a system for implementing a protected activation key is shown. The system 300 for implementing a protected activation key 302 uses two keys (the verification key 230 and a manufacturing key 304) that are paired together to provide an activation key during a manufacturing stage of installation of a software application (e.g., during the operating system build). The activation key 302 is then used to represent and provide proof of a valid license. After the license has been validated, one of the two keys (e.g., the manufacturing key 304) is destroyed. The remaining key (e.g., the verification key 230) is affixed to the target system 120 (or stored within the non-volatile memory of the target system) and is used for any subsequent verification requests. While the remaining key can be used to claim a valid license proof, the remaining key cannot be used to reactivate the license. (Both the verification key and the manufacturing key are required for activation.)

The activation key is injected into the system during manufacture onto a non-volatile storage device 206 (or a TPM) and is not visible or extractable prior to the customer initializing the system.

More specifically, the hard drive 206 comprises a partition wherein information relating to the configuration of the information handling system is stored. A manifest file 216 comprises a plurality of files relating to the information handling system. For example, the manifest file 216 can include information relating to a processor serial number 217, information relating to the system BIOS 218 and other configuration information stored in CMOS 220. In addition, a predetermined selection of files 222, including configuration registers and other customer defined data is stored on the manifest 216. A “signed” file, sometimes referred to herein as an electronic “seal,” 224 is also stored on the hard drive 206. The electronic seal provides an authentication of the contents of the manifest and any tampering with the contents of the manifest will result in the electronic seal being “broken.”

In addition, a kernel for the operating system used in the first boot 226 is stored on the hard drive 206 and information relating to the verification key 230 are stored on the hard drive. The electronic super key 228 includes a combination of key 1 330 and key 2 332.

In one embodiment of the present invention, the security is based on a public key infrastructure (PKI) system using a secure channel such as a secure socket layer SSL-protected link. If the customer does not have a PKI key, the customer can request a symmetric key instead, which is displayed on a web page and can be saved or printed by the customer. Using the secure socket layer (SSL) security system, information relating to the symmetric key is maintained in a secure environment.

When the information handling system 120 arrives at the customer's site, the customer uses the verification key 230 to “break the seal.”

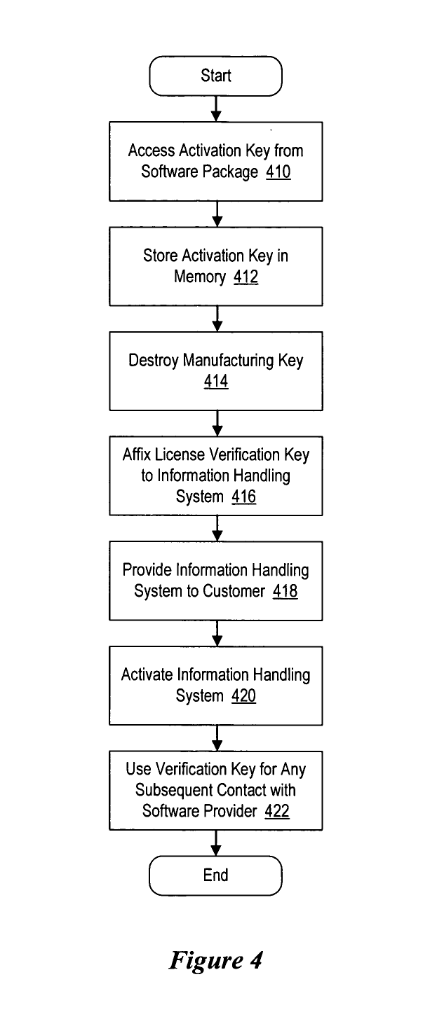

Referring to FIG. 4, a flowchart of the operation of providing a protected activation key is shown. More specifically, when installing software that requires activation onto the information handling system 120, the system 400 starts by accessing a manufacturing key and a verification key from the software being installed at step 410. This access may be via a physical package that accompanies the software or via an electronic access of the software being installed. The combination of the manufacturing key and the verification key provides the activation key. Next, the installed software is activated using the activation key at step 411. Next, the manufacturing key is destroyed at step 414. Destroying the manufacturing key makes the key inaccessible to the user of the computer system. I.e., the manufacturing key is not visible to the user.

A license verification tag containing the verification key is affixed to the information handling system 120 and optionally stored within the non-volatile memory of the information handling system at step 416.

Next, the information handling system is provided to the customer at step 418. The customer can then use the verification key to provide proof of a valid license for any subsequent contact with the software provider.

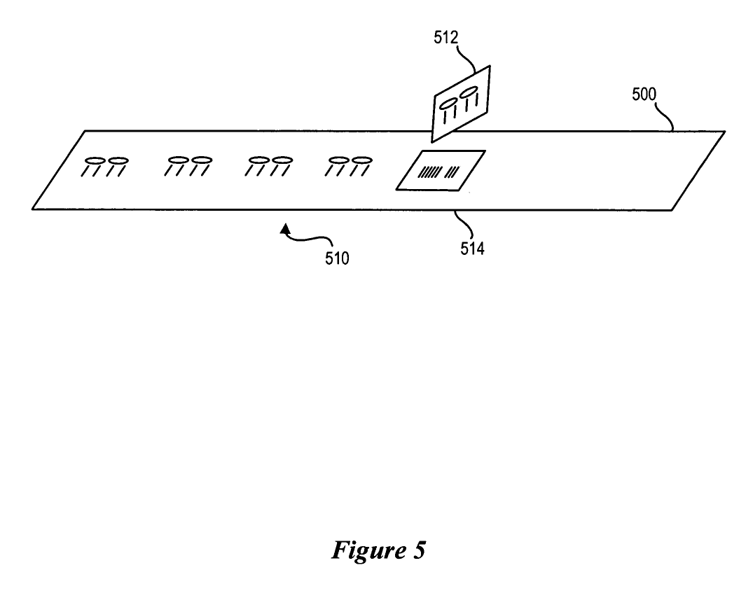

Referring to FIG. 5, a diagrammatic representation of an example implementation of an activation sticker 500 is shown. More specifically, a manufacturing key (e.g., key 2) is paired with a printed verification key (e.g., key 1), but is itself printed on the back side of the sticker 500. Once the activation process is complete, the sticker backing (containing the manufacturing key) is peeled away and destroyed. The remaining sticker 500 is affixed to the target information handling system 120. This remaining sticker contains the remaining key which can be used in any subsequent license verification request.

The activation sticker 500 may be one of a plurality of stickers that are provided by a software application provider on a spool of stickers. Additionally, the activation sticker 500 can include a bar code that is scanned during the manufacturing process. Scanning the bar code during the information handling system manufacturing process would allow the manufacturer to store the manufacturing key or the activation key prior to the manufacturing key being destroyed.

### Other Embodiments

Other embodiments are within the following claims.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Also for example, prior to being destroyed, the manufacturing key or the activation key might be stored in a portion of the information handling system such as the TPM that is not accessible to the user of the information handling system.

Consequently, the invention is intended to be limited only by the spirit and scope of the appended claims, giving full cognizance to equivalents in all respects.

What is claimed is:

1. A method for providing activation key protection comprising:
installing a software application onto an information handling system;
providing a manufacturing key and a verification key for the software application;
combining the manufacturing key and the verification key to provide an activation key;
activating the software application using the activation key; and,
associating the verification key with the software application to enable a user to verify proper activation and license of the software application.

2. The method of claim 1, further comprising
destroying the manufacturing key after activating the software application.

3. The method of claim 1, wherein
the associating is by storing the verification key within non-volatile memory of the information handling system.

4. The method of claim 1, wherein
the associating includes attaching a sticker containing the verification key onto the information handling system.

5. The method of claim 4, wherein
the providing the manufacturing key and the verification key is via the sticker.

6. The method of claim 5, further comprising
destroying the manufacturing key by removing the manufacturing key from the sticker.

7. The method of claim 1, wherein
the installing occurs during the manufacturing of a build to order information handling system.

8. The method of claim 1, wherein
the software application is an operating system.

9. A method of manufacturing an information handling system comprising:
installing a software application onto the information handling system, the software application including an associated manufacturing key and verification key, the manufacturing key and the verification key being combined to provide an activation key;
activating the software application using the activation key; and,
associating the verification key with the software application to enable a user to verify proper activation and license of the software application.

10. The method of claim 9, further comprising:
destroying the manufacturing key after activating the software application.

11. The method of claim 9, wherein
the information handling system includes non-volatile memory; and,
the associating is by storing the verification key within the non-volatile memory of the information handling system.

12. The method of claim 9, wherein
the associating is by attaching a sticker containing the verification key onto the information handling system.

13. The method of claim 12, wherein
the software application includes a sticker, the sticker including the manufacturing key and the verification key.

14. The method of claim 13, further comprising:
destroying the manufacturing key by removing the manufacturing key from the sticker.

15. The method of claim 9, wherein
the installing occurs during the manufacturing of a build to order information handling system.

16. The method of claim 9, wherein
the software application is an operating system.

17. An information handling system comprising:
a processor;
a memory coupled to the processor;
a software application stored on the memory, the software application including an associated manufacturing key and verification key, the manufacturing key and the verification key being combined to provide an activation key, the software being activated via the activation key, the manufacturing key being destroyed after activating the software application, the verification key being stored on the memory and being associated with the software application to enable a user to verify proper activation and license of the software application.

18. The information handling system of claim 17, wherein
the memory includes non-volatile memory; and,
the verification key is stored within the non-volatile memory of the information handling system.

19. The information handling system of claim 17, further comprising
a verification sticker, the verification sticker containing the verification key.

20. The information handling system of claim 17, wherein
the software application is an operating system.
